(19) United States
(12) Patent Application Publication
(10) Pub. No.: US 2015/0197247 A1
(43) Pub. Date: Jul. 16, 2015

(54) MANAGING VEHICLE VELOCITY

(71) Applicant: Jumpei Ichinokawa, Rolling Hills Estates, CA (US)

(72) Inventor: Jumpei Ichinokawa, Rolling Hills Estates, CA (US)

(73) Assignee: Honda Motor Co., Ltd., Tokyo (JP)

(21) Appl. No.: 14/154,283

(22) Filed: Jan. 14, 2014

(51) Int. Cl. B60W 30/14; B60W 40/076

(52) U.S. Cl. CPC B60W 30/143; B60W 40/076; B60W 2050/143

(57) ABSTRACT

Techniques or systems for managing vehicle velocity are provided herein. For example, a system for managing vehicle velocity may receive slope information associated with a driving environment of a vehicle. This slope information may be obtained by cross-referencing a global positioning system (GPS) location of the vehicle with a slope database, which may be used to map the GPS location to corresponding slope information. The GPS location may be obtained from an on-board GPS unit or a third-party GPS device, such as a GPS component of a mobile device. The system may retrieve a current velocity associated with the vehicle and adjust a velocity of a vehicle accordingly, such as by accelerating or decelerating the vehicle. The system may calculate an estimated velocity based on the current velocity and the slope information. In this way, vehicle velocity may be managed or controlled.

### BACKGROUND

Generally, a cruise control system may be used to manage the velocity of a vehicle. Cruise control may be used to automatically control or manage the velocity or the speed of a vehicle, such as a motor vehicle. This may be achieved by enabling the cruise control system to control the throttle of a vehicle and have the cruise control system maintain a steady speed or velocity or cruise speed, which is usually set by a driver of the vehicle. Because cruise control maintains a steady speed, drivers generally find cruise control useful when traffic conditions are steady (e.g., when other vehicles are travelling at about the same speed or when traffic is light, etc.). Additionally, most cruise control systems do not mitigate circumstances or effects which cause the vehicle to have a speed or velocity faster than the steady speed set by the driver, such as when the vehicle is travelling downhill. Cruise control may be useful for long drives by allowing the driver to change positions comfortably while maintaining a constant speed, for example. Further, use of cruise control may result in better fuel efficiency.

Adaptive cruise control systems may incorporate radar or lasers to mitigate collisions with neighboring vehicles by braking when the vehicle is approaching a neighboring vehicle or accelerating when there is more space, thereby providing safety features as well as speed or velocity control.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for managing vehicle velocity are provided herein. Generally, cruise control may be utilized to automate speed or velocity control of a vehicle or motor vehicle. In one or more embodiments, cruise control may be supplemented or managed by adjusting or compensating for the velocity of a vehicle according to or based on a slope associated with a driving environment of the vehicle. It will be appreciated that the slope of the driving environment may be obtained, measured, or determined in a variety of ways. For example, the slope may be measured real time using sensors equipped on-board of the vehicle or devices physically located within the vehicle, such as a mobile device, etc. The slope may also be determined or obtained by cross-referencing a position of the vehicle with a database which maps positions or locations to slope information.

In one or more embodiments, additional information or supplemental information may be used to facilitate management of the velocity of a vehicle. For example, the current velocity, acceleration information, steering angle, contextual information, etc. may be retrieved and used to adjust or determine how or whether or not to adjust the velocity of the vehicle. Regardless, a determination of a target speed or target velocity may be made, and the vehicle may be adjusted to maintain or travel about the target velocity. As an example, a control component (e.g., velocity or cruise control component) may adjust the velocity of the vehicle such that the velocity falls within a range of or is about the target velocity. In this way, fuel efficiency and safety may be promoted.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for managing vehicle velocity, according to one or more embodiments.

FIG. 2 is an illustration of an example flow diagram of a method for managing vehicle velocity, according to one or more embodiments.

FIG. 3 is an illustration of an example flow diagram of a method for managing vehicle velocity, according to one or more embodiments.

FIG. 4 is an illustration of an example driving environment, according to one or more embodiments.

FIG. 5 is an illustration of an example driving environment, according to one or more embodiments.

FIG. 6 is an illustration of an example driving environment, according to one or more embodiments.

FIG. 7 is an illustration of an example interface associated with a system for managing vehicle velocity, according to one or more embodiments.

FIG. 8 is an illustration of an example velocity versus time graph associated with a system for managing vehicle velocity, according to one or more embodiments.

FIG. 9 is an illustration of an example computer-readable medium or computer-readable device including processor-executable instructions configured to embody one or more of the provisions set forth herein, according to one or more embodiments.

FIG. 10 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

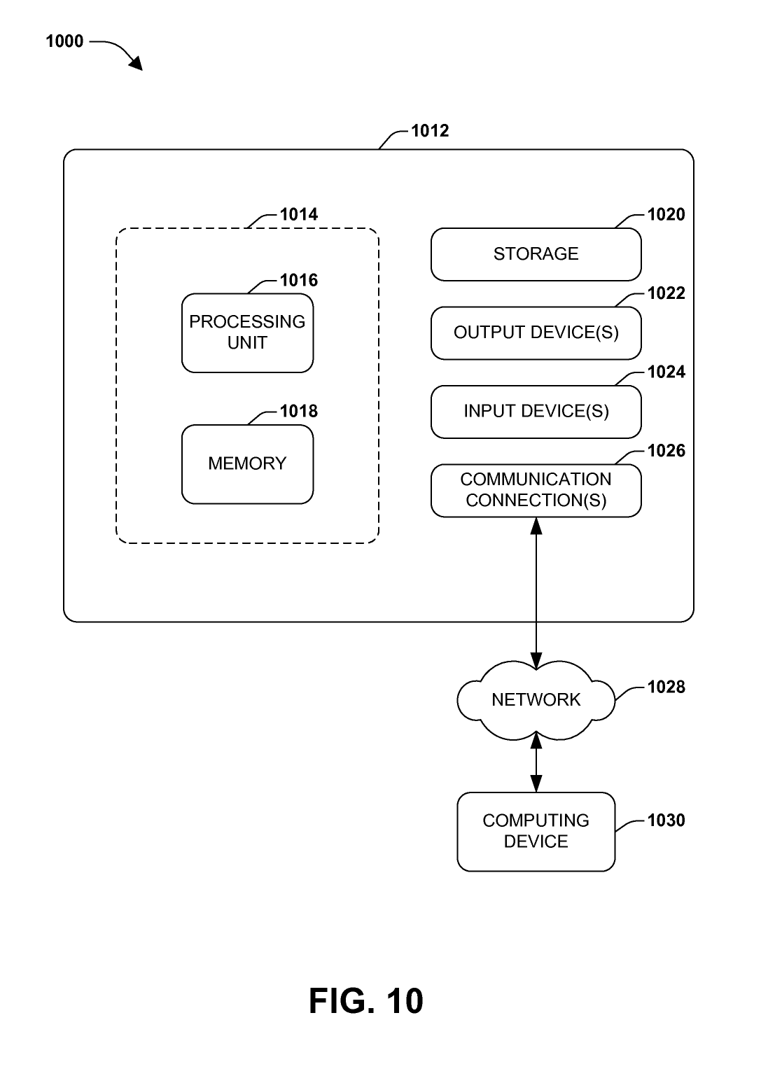

For one or more of the figures herein, one or more boundaries or lines, such as boundary 1014 of FIG. 10, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

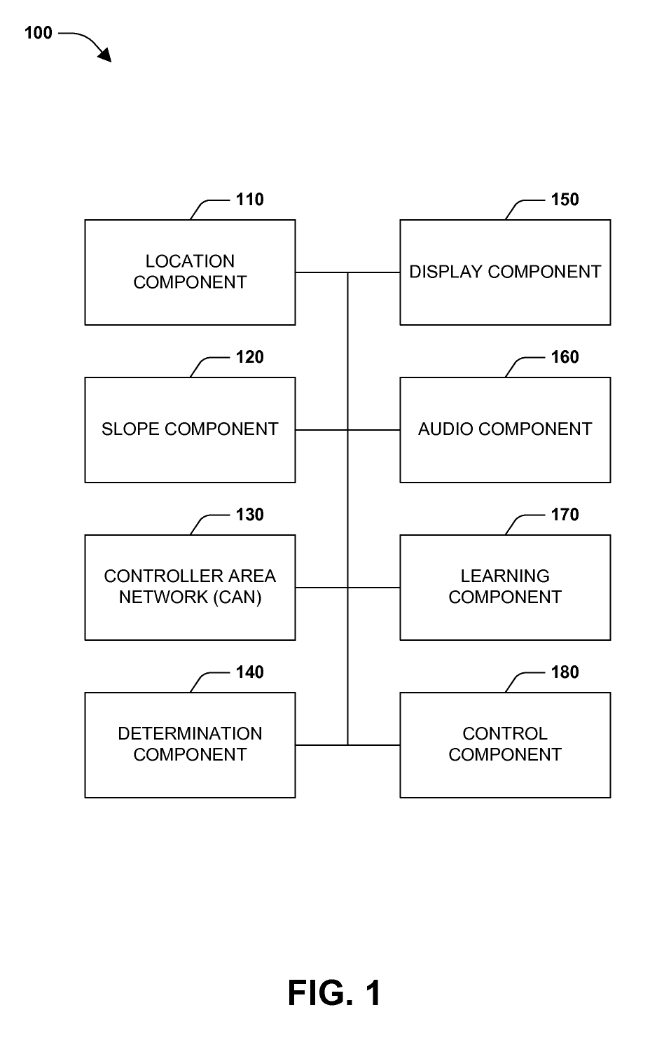

FIG. 1 is an illustration of an example component diagram of a system 100 for managing vehicle velocity, according to one or more embodiments. The system 100 may include a location component 110, a slope component 120, one or more controller area networks (CANs) 130, a determination component 140, a display component 150, an audio component 160, a learning component 170, and a control component 180. In one or more embodiments, the system 100 may utilize slope information received or acquired by the slope component 120 to adjust or influence operations associated with a vehicle, such as the velocity of the vehicle. Additionally, such information may be utilized to enable or disable other features associated with a vehicle.

When a vehicle is travelling in a driving environment, the vehicle is generally en route from an origin location to a destination or destination location. The vehicle may travel along a route where one or more portions of the route include one or more road segments. To this end, a driving environment may include one or more portions of a route or one or more of the road segments. These portions of the route or road segments may be associated with different characteristics, such as slope information, for example. In other words, different portions of a driving environment, road segments, or different portions of a route may be associated with corresponding slope information, among other things.

Slope information may include a grade, include, gradient, pitch, slope angle, percentage, ratio, etc., which may be utilized to describe a topological feature associated with a driving environment, road segment, route, or portion thereof. Slope information may include topological data associated with the driving environment of the vehicle. In one or more embodiments, the slope information may be retrieved by cross-referencing a current location of the vehicle with a slope information database or database (not shown). The slope information may be associated with the current location of the vehicle. It will be appreciated however, that the slope component 120 may measure the slope of the vehicle in real time, by using sensors on-board the vehicle, for example. Regardless, the slope information may include topological data, such as slope angles, and be associated with road segments, route portions, or the driving environment in which the vehicle is travelling.

In one or more embodiments, the system may include a location component 110 which may receive location information associated with a vehicle. For example, the location component 110 may receive a global positioning system (GPS) location associated with a vehicle. GPS readings may be received from a telematics component on-board the vehicle or via other sources. In one or more embodiments, the location component 110 may access a GPS location or a current location of a vehicle via a GPS unit or GPS component of a mobile device. As an example, a GPS enabled mobile device may be communicatively coupled with a vehicle. The vehicle may retrieve a location associated with the mobile device (and thus the location of the vehicle) when the mobile device is coupled to, docked with, or otherwise connected or communicatively coupled with the vehicle. For example, the mobile device may have a wired connection, a wireless connection, Bluetooth connectivity, or the like with the vehicle.

In other embodiments, the location component 110 may be a global positioning system (GPS) receiver that may receive a current location or a GPS location associated with the vehicle. It will be appreciated that other types of positioning systems may be utilized. The position or location of a vehicle received by the location component 110 may be utilized to determine a slope by cross-referencing the location with a database of slope information. In other words, in one or more embodiments, slope information may be obtained from a slope database which correlates the slope information with position or location information. As an example, the cross-referencing may be achieved using a telematics channel, telematics component, communication component, an internet connection, a wireless connection, or other connectivity.

For example, a slope component 120 may reference slope information associated with a driving environment of a vehicle when the location of the vehicle is determined or received by the location component 110. The slope component 120 may have access or be communicatively connected to or coupled to a database or slope database (e.g., which may be external to the system 100 in some embodiments). The database or slope database may include or contain pairings of locations or positions with slope data or slope information.

As an example, the location component 110 may return GPS coordinates (e.g., a GPS location associated with the vehicle) which may be passed to the slope component 120 which utilizes those coordinates to lookup or determine corresponding slope information for the coordinates by performing a lookup by searching the slope database for matching or nearby coordinates. The slope component 120 may receive coordinates (e.g., GPS coordinates) for the location of the vehicle from the location component 110 and receive slope information (e.g., from a slope database) based on the GPS location of the vehicle, such as by cross-referencing the location information or GPS coordinates with the slope database or database. In this way, the slope component 120 may reference or receive slope information associated with the driving environment of the vehicle, route, road segment, etc.

In one or more embodiments, a vehicle utilizing the system 100 of FIG. 1 may be equipped with one or more slope sensors (not shown) which may measure the slope of the terrain, driving environment, route, or road segment through which a vehicle is travelling. In such embodiments, the location component 110 may be omitted or the location of the vehicle may merely be utilized to supplement slope information taken or measured by the slope sensors of the vehicle. In other embodiments, the slope component 120 may receive slope information from a mobile device coupled to the system 100, such as via a communications or interface component (not shown). For example, a mobile device may be equipped with location capabilities, such as GPS, and handle cross-referencing of the location of the vehicle with a slope database. Accordingly, in this example, the mobile device may return both the slope information and/or the location of the vehicle to the slope component 120 and the location component 110, respectively. As another example, the mobile device may be equipped with one or more slope sensors which may determine a slope associated with the mobile device, and thus slope information of the vehicle. Accordingly it will be appreciated that because the slope may be determined by one or more slope sensors (e.g., on a vehicle or on a mobile device) in some embodiments, the location component 110 may be omitted from system 100 in those embodiments.

A controller area network (CAN) 130 for the system 100 may receive one or more vehicle characteristics or one or more driving characteristics from one or more other components, systems, or units of a vehicle. For example, the CAN 130 may receive the current speed or velocity of the vehicle, longitudinal, vertical, lateral acceleration information associated with the vehicle, a steering angle, throttle angle, whether one or more features (e.g., anti-lock brakes, all-wheel drive, skid control, traction control, vehicle stability assist) are enabled or disabled, etc. Additionally, the CAN 130 may receive other information relating to engine conditions, transmission control, and the like.

In one or more embodiments, other components, such as a communication component (not shown), may retrieve or receive additional characteristics or vehicle characteristics such as a weight of a vehicle, a class of a vehicle (e.g., light, heavy, full-size, compact, passenger, long-haul, etc.), a load associated with the vehicle, a type of vehicle, transmission type (e.g., automatic or manual), drive type (e.g., front-wheel drive, all-wheel drive, rear-wheel drive). Further, the communication component may receive environmental characteristics associated with the driving environment of the vehicle. The communication component may receive weather information or road surface information associated with the driving environment, routes, road segments, or portions thereof. For example, the communication component may receive environmental characteristics such as the outside temperature, ambient temperature, road surface temperature, road surface conditions (e.g., icy, slick, wet, frozen, salt covered, etc.).

The communication component may also receive map based characteristic information, which may include slope information, location or proximity of upcoming side streets or intersections, distance to an upcoming stop sign, traffic light, or other traffic signal, a number of lanes associated with a roadway or road segment, a type of road surface (e.g., pavement, asphalt, concrete, brick, gravel, dirt, etc.), type of road (e.g., highway, local, interstate, etc.), length of a road segment, shape or curvature of a road segment, speed limit, or other characteristic associated therewith. Additionally, the communication component may receive other supplemental information, such as a time of day, day of the week, current traffic conditions, etc.

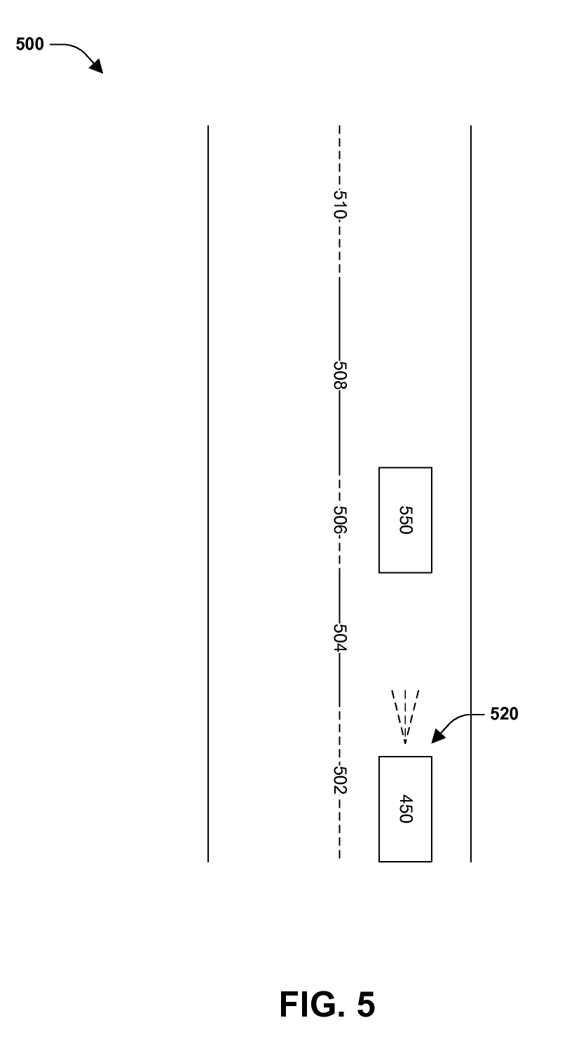

It will be appreciated that other components may be implemented to facilitate safety and/or fuel efficiency. For example, the system 100 may include an image capture component (not shown) or other sensors or components which facilitate collision avoidance (as will be described with reference to FIG. 5), such as radar, laser, or infrared sensors.

A determination component 140 may generate a determination or determine an action, such as adjusting a throttle position, and thus the speed or velocity of the vehicle based on characteristics associated with the vehicle, such as vehicle characteristics, driving characteristics, whether or not features of the vehicle are enabled or disabled, environmental characteristics, map based characteristics, supplemental information or characteristics, and slope information associated with the driving environment of the vehicle. In other words, the determination component 140 may determine whether to accelerate, decelerate, coast, maintain speed, release the throttle, etc. based on the velocity of the vehicle, current velocity, or slope information associated with the driving environment of the vehicle. The determination component 140 may operate with one or more goals or according to one or more modes (e.g., fuel efficiency, maintaining a more constant coasting speed, etc.). As used herein, ‘coast’ may mean maintaining a substantially constant speed or velocity or merely releasing the throttle as to not apply gas or accelerate.

In one or more embodiments, the determination component 140 may determine a throttle position, acceleration, deceleration, etc. based on a lookup table. For example, when the slope of a road segment is determined to be X amount or Y % grade, adjust the velocity of the vehicle to be a target velocity Z. The control component 180 may compare the current velocity of the vehicle with the target velocity provided by the determination component 140 and/or corresponding lookup table and adjust the velocity accordingly. In this way, the control component 180 may adjust the velocity of the vehicle by accelerating or decelerating the vehicle (e.g., applying the brakes, gas, or throttle). The control component 180 may thus control the velocity of the vehicle based on the determination generated by the determination component 140 or otherwise implement the determination made by the determination component 140.

The determination component 140 may facilitate economic vehicle velocity management by analyzing features or characteristics of upcoming or approaching terrain. For example, when a driving is utilizing a mobile device, such as a smartphone, for navigation purposes, a proposed route for the driver and the vehicle are known in advance. Accordingly, characteristics captured by the slope component 120 or the communication component may be analyzed in view of current, preceding, upcoming, or approaching terrain, driving environments, routes, or road segments. For example, the determination component 140 may engage the throttle to accelerate on a downgrade or downhill portion of a road segment when the next maneuver associated with the proposed route is known to be a road segment associated with an uphill portion or an upgrade, thereby mitigating over throttle on upgrades and under throttle on downgrades, for example. In other example, the determination component 140 may adjust a target speed or target velocity of the vehicle to be greater than or less than a previous target speed or previous target velocity. In this way, the determination component 140 may provide a temporary velocity change (e.g., the length of time associated with a velocity change may be based on slope information or an estimated velocity) or a permanent velocity change.

In one or more embodiments, the determination component 140 may calculate an estimated velocity for a vehicle based on the current velocity of the vehicle and slope information. The determination component 140 may cross-reference the estimated velocity with other information, such as the speed limit associated with the road segment on which the vehicle is travelling, and provide a determination accordingly. For example, if a vehicle is travelling downhill on a road segment within a driving environment, the location component 110 of the system 100 may determine a location or current location of the vehicle (e.g., positioning or coordinates of the vehicle, and thus coordinates for that portion of the road segment). The slope component 120 may obtain slope information for the portion of the road segment the vehicle is travelling on, as well as preceding or subsequent portions of the road segment or route the vehicle is travelling along. If the vehicle is travelling downhill, on a decline, or downgrade, the determination component 140 may estimate or calculate an estimated velocity for the vehicle based on the current speed of the vehicle on the slope angle or percent grade associated with the slope. The determination component 140 may cross-reference the estimated velocity with a speed limit and adjust the throttle or brakes accordingly, such that the velocity of the vehicle does not exceed the speed limit or a threshold above the speed limit. In this way, a velocity of the vehicle may be adjusted based on the estimated velocity and the slope information.

The system 100 may include one or more components which provide notifications to a driver or other occupants of a vehicle regarding the determination generated by the determination component 140 or information associated with the driving environment. For example, a display component 150 may render or display one or more notification for the driver. As another example, an audio component 160 may render audio notifications for the driver of the vehicle to alert him or her of automated actions which may be performed by the control component 180. In this way, the system 100 may render suggestions or suggestion notifications for a driver of a vehicle to facilitate a change in a driving style of a driver or an operator of a vehicle. For example, a suggestion may include indicating to a driver to mitigate or cease throttling a vehicle during a portion of a road segment, such as a road segment associated with a downhill portion followed by an uphill portion. As another example, when the determination component 140 identifies a grade or downhill portion which exceeds a threshold grade or slope, one of the notification components may indicate to the driver or render a notification or suggestion that he or she should prepare to brake accordingly.

It will be appreciated that other components or notification components may be utilized to implement or provide a driver or occupants of a vehicle with notifications related to the determination, vehicle operations, the velocity of the vehicle, enabling or disabling features of the vehicle, a driving environment through which the vehicle is travelling, etc. For example, when the determination component 140 decelerates a vehicle or makes a corresponding determination, the control component 180 may implement that determination and a notification component (not shown) may alert the driver by providing force feedback, such as by vibrating the steering wheel or the seat, for example. When the system 100 arrives at a determination, a variety of types of notifications may be presented or rendered for drivers or occupants of the vehicle. Explained yet in another way, notifications may be visual, audio, tactile, etc. For example, a notification may include a blinking light, flashing an LED, etc. In one or more embodiments, a notification associated with an upcoming acceleration or provided while a vehicle is accelerating may include vibrating the gas pedal. Similarly, a notification component may vibrate a brake pedal of the vehicle when decelerating, for example. The audio component 160 may render a beep when a determination is made, such as to accelerate or decelerate. In other embodiments, the audio component 160 may play a message, such as, “engaging throttle” or “preparing to brake”, for example.

Additionally, the display component 150 may display other information or driving environment information, such as slope information, a slope angle, degree, a length of an incline or decline, road surface conditions, weather conditions, the velocity of the vehicle, a map of the driving environment, a route or proposed route on which the vehicle is travelling, associated road segments, one or more features which are enabled or disabled, date and time, etc. The display component 150 may be implemented as a display on a dashboard, a console, or a heads-up display (HUD), and the like.

As an example, if the display component 150 renders a map of a driving environment or a route from an origin location to a destination location, the route may be color coded to indicate portions of the route or road segments (e.g., overlaid on the map) where the vehicle will ascend or descend. Unlike a topological map which is color coded by height, the color coding of the route is based on the direction of travel. For example, when a user travels from a first location to a second location going downhill or descending, the display component 150 may render that portion of the route in red. Conversely, when the user travels from the second location to the first location and travels uphill, the display component 150 may render the route in blue. The display component 150 may render different shades of a color based on a steepness of an incline or decline, grade, degree, slope angle, etc.

It will be appreciated that different characteristics or information received by the system 100 may affect the determination generated by the determination component 140 in different ways. In other words, the determination may be based on vehicle characteristics, driving characteristics, features of the vehicle, environmental characteristics associated with the driving environment, map based characteristics associated with the driving environment, or other supplemental information. For example, during inclement weather conditions, a vehicle with rear-wheel drive may be more susceptible to fishtailing. As a result of this, when the determination component 140 makes a determination to throttle a vehicle (e.g., for an approaching incline), the determination component 140 may base the amount of throttle on a slope of the upcoming or approaching incline, a current velocity of the vehicle and a drive train system of the vehicle. For example, the determination component 140 may throttle a rear-wheel drive vehicle less than a front-wheel drive, all-wheel drive, or four-wheel drive vehicle for an incline.

In other embodiments, the determination component 140 may generate a determination to accelerate, decelerate, coast, or maintain speed based on the weather or road conditions. For example, if the slope component 120 references a location of a vehicle with a downhill road segment which is steep and it is determined (e.g., such as by a communication component) that a road segment near the location of the vehicle is icy, the determination component 140 may decelerate the vehicle based on the slope and the icy conditions. In one or more embodiments, the determination component may activate features automatically or initiate a notification or suggestion for a driver or occupant to activate features based on slope information and/or road surface conditions received by the slope component 120. As an example, when the vehicle is approaching a downhill road segment which may be icy, the determination component 140 may suggest or engage the vehicle in a four-wheel drive mode (e.g., four-wheel drive high) or setting. In other embodiments, the determination component 140 may have the display component 150 suggest that the driver stop the vehicle and engage the vehicle in four-wheel drive low mode based on the slope information and/or weather or road conditions.

The determination component 140 may calculate an estimated velocity for a vehicle based on a current velocity for the vehicle and slope information for a road segment on which the vehicle is travelling. Additionally, other information, such as road surface conditions, temperature, weather, speed limits of corresponding road segments, etc. may be considered. As an example, when a vehicle is travelling downhill, the determination component 140 may calculate an estimated velocity for the vehicle based on upcoming slope information, the current velocity of the vehicle, vehicle characteristics (e.g., the weight of the vehicle or a load associated with the vehicle). To this end, the determination component 140 may initiate braking or deceleration prior to a threshold velocity, such as a speed limit, for example. In other words, the determination component 140 may anticipate an increase in speed or velocity based on slope information of an upcoming or approaching road segment (e.g., which may be obtained from route navigation) and brake in a smoother or continuous manner, rather than when the vehicle reaches a threshold speed.

In one or more embodiments, the determination component 140 may generate a determination to accelerate, decelerate, etc. based on map based characteristics, such as upcoming side streets or intersections along a route or a road segment, upcoming stop signs or distance thereto, upcoming traffic lights or distance thereto, the number of lanes associated with a road segment, a type of road segment (e.g., highway, local, non-highway), length of a road segment, speed limits, shape of a curve or road segment, radius of a curve, length of a curve or chord, etc. For example, if a vehicle is set to cruise at 45 miles per hour (mph), and a vehicle is approaching an intersection with a stop sign, the determination component 140 may decelerate the vehicle at a predetermined distance from the stop sign as the vehicle approaches the stop sign. As another example, when the determination component 140 determines that a vehicle is currently travelling on a relatively flat road segment (e.g., having little variation in topography) and that an upcoming road segment is associated with a decline or downhill segment, the determination component 140 may have the control component 180 decelerate or mitigate application of the throttle prior to arriving at the upcoming downhill road segment. In other words, the determination component 140 may coast a vehicle at a flat road segment in anticipation of an upcoming downhill segment to promote greater fuel economy for a vehicle. As yet another example, the determination component may coast the vehicle to the stop sign by disabling cruise control or merely not applying additional throttle. In this way, safe, fuel efficient driving and/or vehicle operation may be promoted.

Similarly, the determination component 140 may determine whether to accelerate, decelerate, etc. a vehicle based on supplemental information, such as date and time or traffic conditions. For example, the determination component 140 may have a vehicle decelerate more on a downslope at night than during the day. As another example, the determination component 140 may accelerate the vehicle more cautiously during heavy traffic hours, rush hour, etc. In other words, when a vehicle is travelling uphill, the determination component 140 may cause the vehicle to accelerate to a set point velocity or target velocity slower at night or when traffic is heavy, for example. The determination component 140 may also adjust a target velocity (e.g., cruise control velocity) based on most any of the aforementioned factors or characteristics. For example, the determination component 140 may adjust the target velocity of the vehicle to be 25 mph when approaching a curve, such as an on ramp or exit ramp for a highway. To this end, the determination component 140 may cause the vehicle to accelerate or decelerate accordingly. As another example, when the vehicle is approaching an uphill curve, the determination component 140 may compensate or adjust for acceleration to a target velocity to be lower or less than when the vehicle is approaching a relatively straight uphill road segment.

In one or more embodiments, the determination component 140 may have the display component 150 or the audio component 160 provide a driver with a notification which indicates that the driver should (manually) accelerate or decelerate. In such embodiments, the learning component 170 may learn braking patterns of drivers and calculate positions or coordinates where a driver may be provided with a notification to brake based on the brake pattern of the driver, the load of the vehicle, the velocity of the vehicle, road surface conditions, or slope information associated with the road segment. For example, if a driver has a history of depressing the brake pedal of his or her vehicle slowly (e.g., a soft braking profile), the learning component 170 may record these driving characteristics and provide the determination component 140 with the characteristics. The determination component 140 may receive driving profile information from the learning component 170 and utilize the profile information or driving characteristic information to make a determination as to whether or not to accelerate, decelerate, a timing associated with implementing the determination, a magnitude of acceleration or deceleration, a position or location to initiate implementation of the determination. In this way, the determination component 140 may suggest coordinates, a position, or a location where a notification component, such as the display component 150 or the audio component 160, may provide a notification or alert to a driver to take an action, such as accelerating or decelerating, based on the driving profile of the driver, a brake pattern associated with the driver, a desired brake pattern, an estimated braking distance, etc.

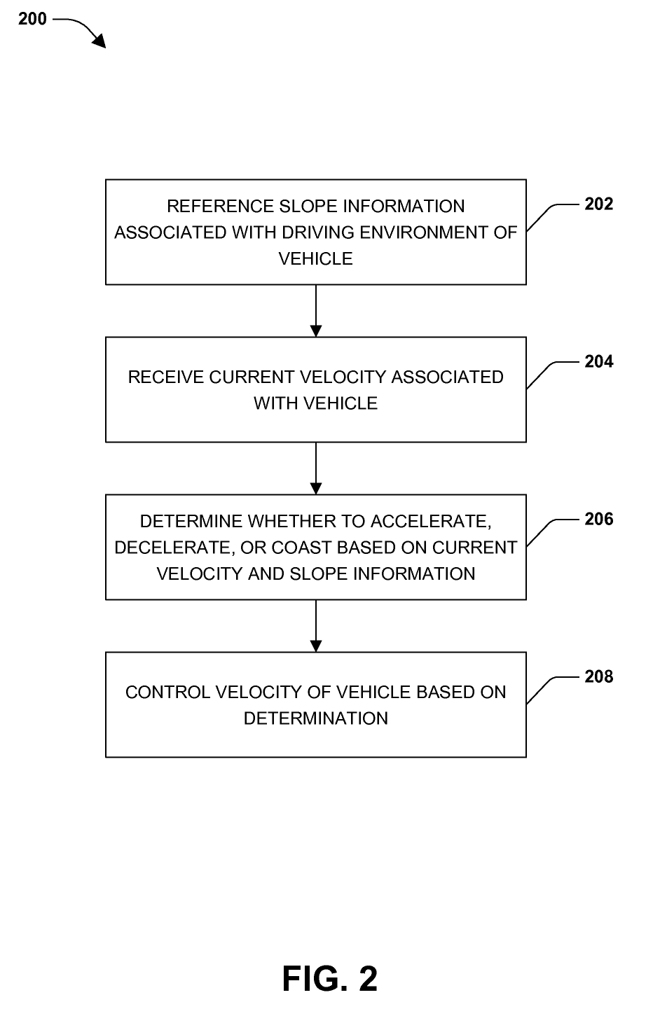

FIG. 2 is an illustration of an example flow diagram of a method 200 for managing vehicle velocity, according to one or more embodiments. At 202, slope information associated with the driving environment of a vehicle may be referenced, such as by performing a lookup in a slope database against coordinates, for example. At 204, the current velocity of the vehicle or the speed associated with the vehicle may be received (e.g., from a CAN of the vehicle). At 206, the method 200 includes making a determination whether to accelerate, decelerate, or coast based on the current velocity and the slope information. At 208, the velocity of the vehicle may be adjusted based on the determination.

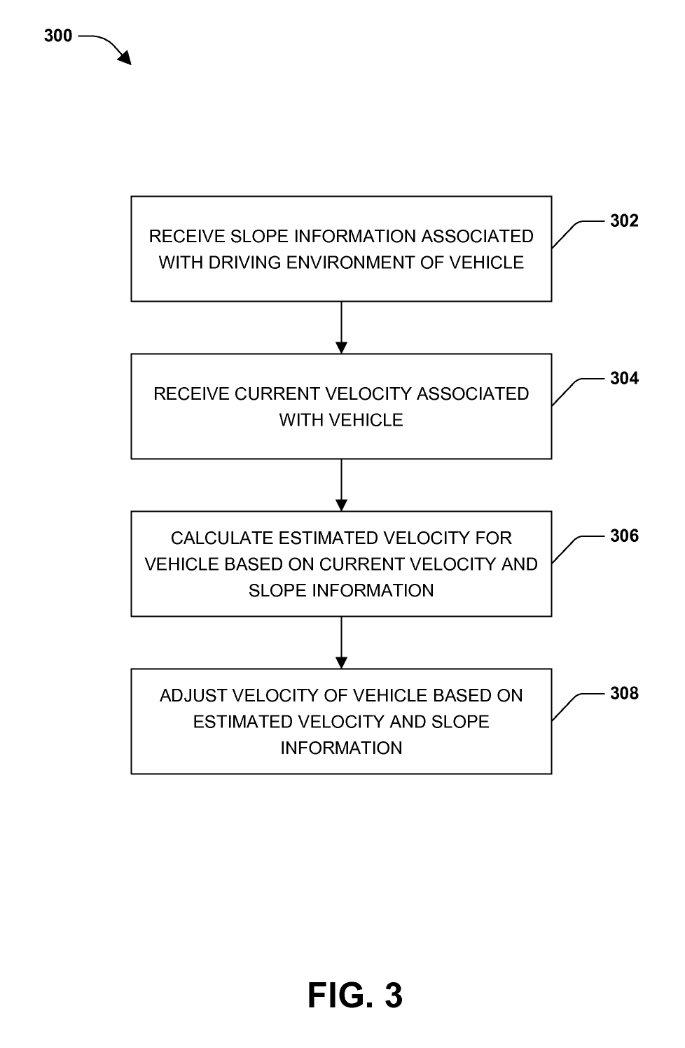

FIG. 3 is an illustration of an example flow diagram of a method 300 for managing vehicle velocity, according to one or more embodiments. At 302, slope information may be received where the slope information may be associated with the driving environment of the vehicle. At 304, the current velocity associated with the vehicle may be received. At 306, an estimated velocity for the vehicle may be calculated based on the current velocity and the slope information. At 308, the velocity of the vehicle may be adjusted based on the estimated velocity and the slope information.

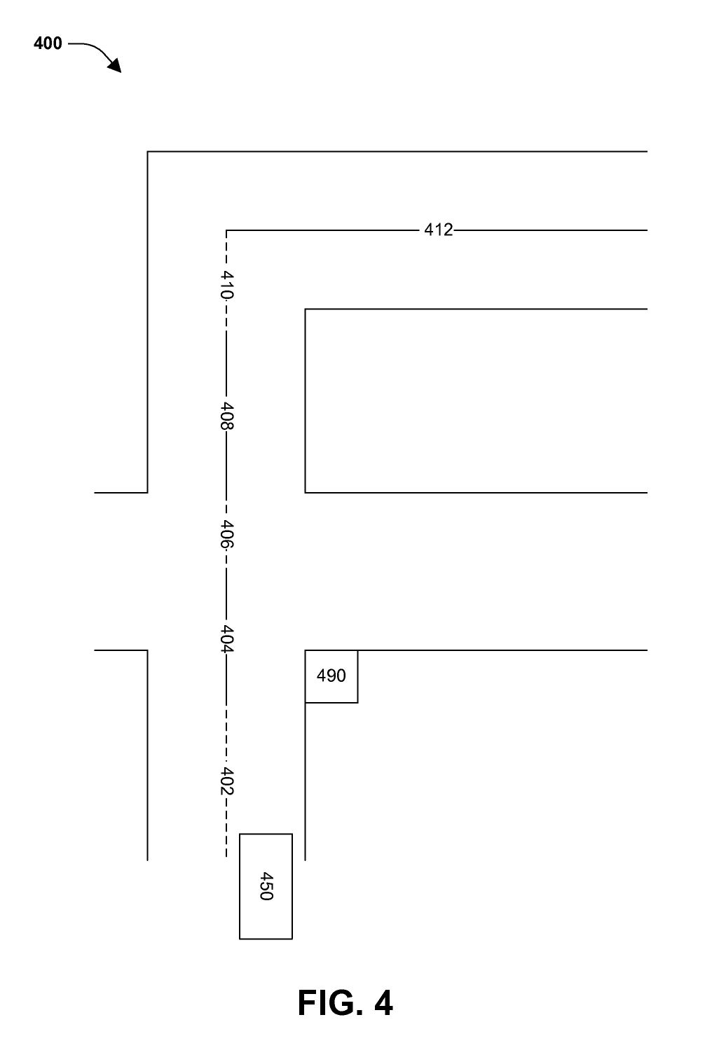

FIG. 4 is an illustration of an example driving environment 400, according to one or more embodiments. In the driving environment 400 of FIG. 4, a vehicle 450 may navigate along a route which includes one or more portions of road segments 402, 404, 406, 408, 410, and 412. These road segments may be associated with slope information which corresponds to the respective road segments 402, 404, 406, 408, 410, and 412. Stop sign 490 is located at the intersection where road segments 404 and 406 meet. In one or more embodiments, a determination component, such as determination component 140 of FIG. 1 may have the control component 180 decelerate the vehicle or disengage the throttle based on the location of the stop sign 490.

FIG. 5 is an illustration of an example driving environment 500, according to one or more embodiments. In the driving environment 500 of FIG. 5, a vehicle 450 is travelling along a route which include road segments 502, 504, 506, 508, and 510. In one or more embodiments, object detection may be implemented to mitigate collisions with other vehicles, such as vehicle 550, or obstacles. Collision avoidance or object detection may be implemented via sensors 520 on-board vehicle 450, such as image capture components, radar, lasers, and the like.

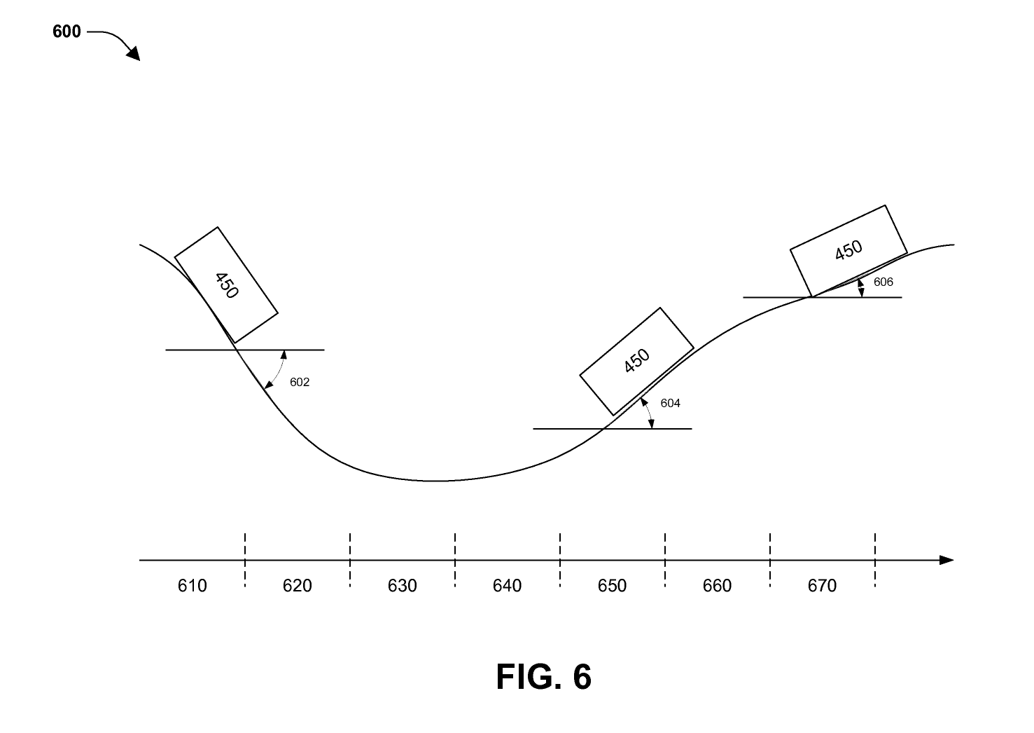

FIG. 6 is an illustration of an example driving environment 600, according to one or more embodiments. In FIG. 6, a vehicle 450 is travelling along a route with one or more route portions 610, 620, 630, 640, 650, 660, and 670. The respective route portions are associated with corresponding slope information. For example, route portion 620 is associated with slope angle 602, route portion 650 is associated with slope angle 604, and route portion 670 is associated with route portion 606. With reference to the system 100 for managing vehicle velocity of FIG. 1, the determination component 140 may suggest or generate a variety of determinations based on a number of characteristics. For example, in some embodiments, the determination component 140 may mitigate application of the brakes when travelling downhill, such as along road segments 610 and 620. In this way, fuel economy may be promoted. In other embodiments, the determination component 140 may decelerate the vehicle 450 if it is determined that the estimated velocity of the vehicle may exceed the speed limit associated with an upcoming road segment. For example, if it is determined that the estimated velocity of the vehicle 450 at road segment 630 is greater than the speed limit associated with road segment 630, the determination component 140 may initiate braking or not supplying additional throttle at road segment 620 or 610.

In other embodiments, such as when the estimated velocity does not exceed the speed limit associated with an upcoming road segment, the determination component 140 may apply throttle or accelerate the vehicle 450 in view of or based on an approaching incline (e.g., road segments 650, 660, and 670). In other words, the determination component 140 may calculate an estimated velocity for road segment 630 or 640 and determine whether additional throttle would be desirable to maintain an appropriate speed (e.g., within a threshold range of the corresponding speed limit) going uphill at 650, 660, or 660.

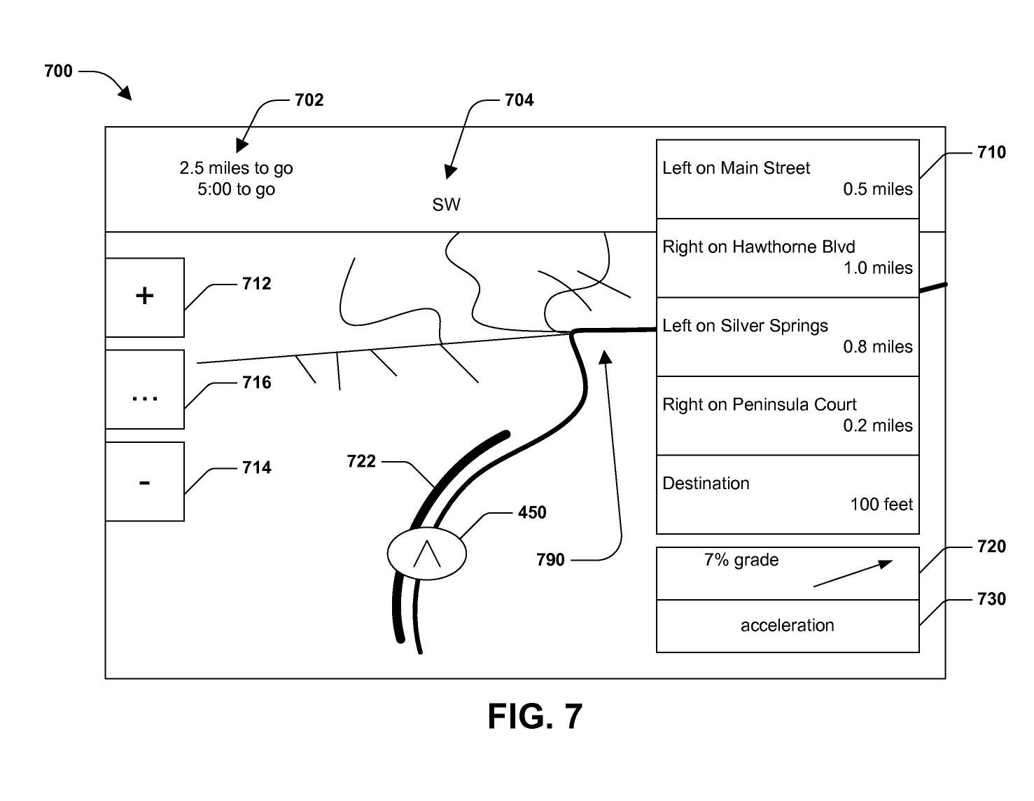

FIG. 7 is an illustration of an example interface 700 associated with a system for managing vehicle velocity, according to one or more embodiments. 702 is a time and/or distance indicator associated with route information for a route or proposed route for a vehicle. 704 is a direction indicator, and in FIG. 7, the vehicle 450 is travelling southwest along the route. 712 and 714 provide zoom options for the map, while 716 is a menu button which enables a user or driver to explore additional options for velocity control. At 710, turn by turn navigation is provided and may include street names, distances, and navigation directions. At 720, an indicator may render a slope angle, grade, or other slope information for a user. At 730, a suggestion or determination information may be presented. For example, the determination component 140 may have the control component accelerate the vehicle, as seen at 730.

As previously discussed, the magnitude of acceleration may be based on a variety of factors, such as curvature of a road segment 722, weather conditions (e.g., brake earlier on downhill when road conditions are wet, icy, or when snow is reported), or map based characteristics, such as a turn 790 or stop sign. In one or more embodiments, a determination component (e.g., determination component 140 of FIG. 1) may cause the vehicle to accelerate, decelerate, or adjust a set point or target velocity for the vehicle. Further, the determination component 140 may make such adjustments on a temporary or long-term basis. For example, if terrain or road segments pursuant to turn 790 are sharp or are associated with a lower speed limit, the determination component 140 may decrease the target velocity of the vehicle. As another example, if the road segment is relatively straight and flat (e.g., little elevation change or few hills), the determination component 140 may merely decelerate the vehicle about turn 790 or momentarily to navigate the turn 790 and allow the vehicle to resume a previously determined target velocity along the road segment after the turn 790. It will be appreciated that the target velocity may be selected based on one or more vehicle characteristics, such as the weight of the vehicle, whether the vehicle has manual or automatic transmission, is engaged in four-wheel drive along with other factors, such as the curvature of the road segment or turn 790, or speed limits associated therewith, for example.

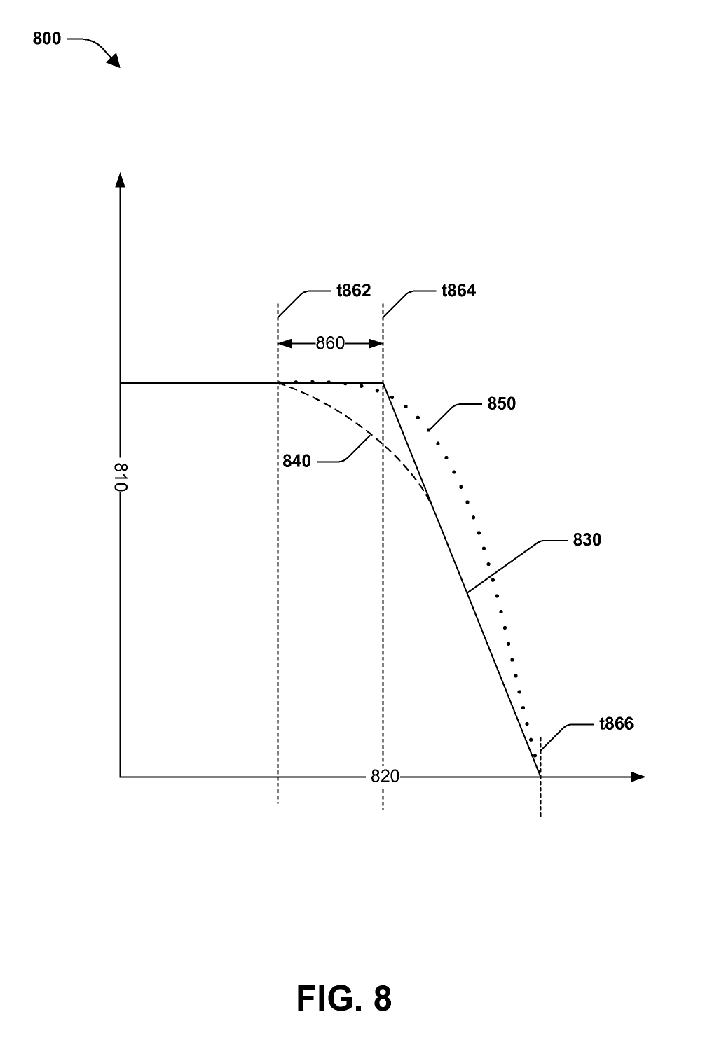

FIG. 8 is an illustration of an example velocity versus time graph 800 associated with a system for managing vehicle velocity, according to one or more embodiments. Axis 810 is indicative of a velocity of a vehicle, while axis 820 is indicative of an elapsed time. In this example graph 800, three different velocity over time scenarios 830, 840, and 850 are illustrated. Trace 830 is indicative of the velocity of a vehicle travelling on a relatively flat road segment. As seen at 830, if the driver releases the throttle, the vehicle may begin decelerating at time t864 and continues to do so through time t866. During this time from t864 to t866, trace 830 corresponds with the vehicle travelling along a relatively flat portion of a route or a relatively flat road segment. Traces 840 and 850 are indicative of other scenarios where deceleration may occur (e.g., such deceleration may or may not be facilitated by the determination component 140 of the system 100 of FIG. 1) while the vehicle is travelling along a relatively flat road segment (e.g., t862 through t864) to a downhill road segment or decline (e.g. t864 through t866). For example, trace 850 illustrates a slightly different scenario where the gas or throttle is released at time t864. Because the vehicle is no longer being throttled at time t864 and the vehicle is travelling along a decline, the velocity of the vehicle does not taper off as quickly as trace 830. Trace 840 illustrates an example where the determination component 140 may decelerate the vehicle prior to the vehicle reaching a road segment associated with a decline. Because of this deceleration, the vehicle may take advantage of the topology of surrounding road segments and adjust a target velocity or set acceleration or deceleration accordingly. To this end, an improvement in fuel economy may be seen at window 860 (e.g., between trace 830 and 840).

Regardless, the determination component 140 may decelerate or stop applying throttle to a vehicle earlier or prior to the vehicle reaching a downhill road segment. The amount of distance prior to the downhill road segment at which the vehicle decelerates may be based on characteristics associated with the vehicle, such as vehicle characteristics, driving characteristics, whether or not features of the vehicle are enabled or disabled, environmental characteristics, map based characteristics, supplemental information or characteristics, and slope information associated with the driving environment of the vehicle. For example, if an upcoming road segment is relatively steep (e.g., in the downhill direction) or greater than a threshold slope angle, the determination component may adjust a target velocity to be lower or decelerate the vehicle to a greater extent than when the vehicle is approaching a less steep downhill road segment.

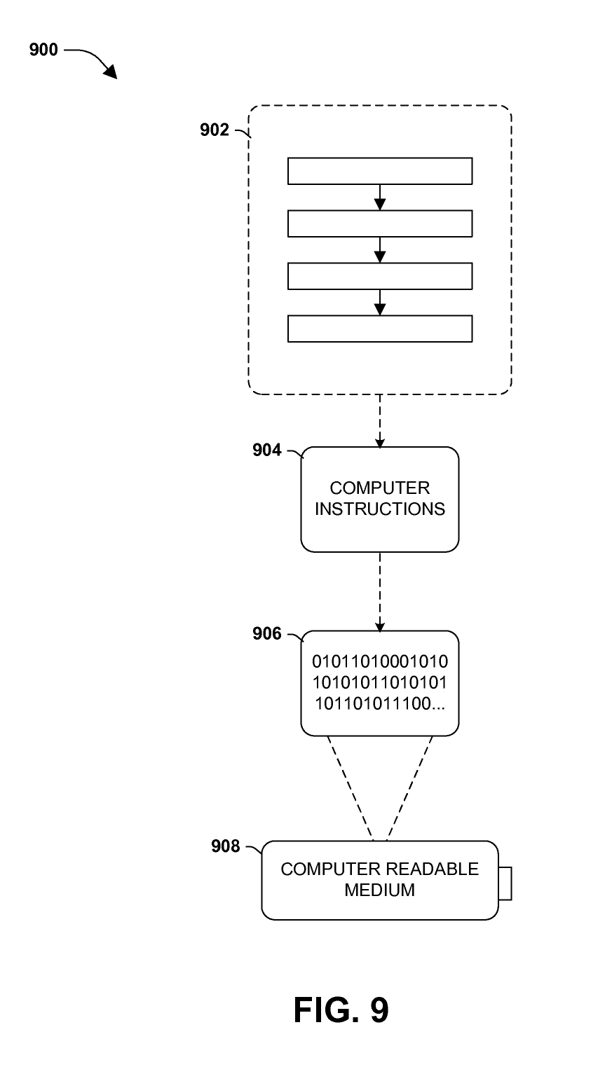

Still another embodiment involves a computer-readable medium including processor-executable instructions configured to implement one or more embodiments of the techniques presented herein. An embodiment of a computer-readable medium or a computer-readable device devised in these ways is illustrated in FIG. 9, wherein an implementation 900 includes a computer-readable medium 908, such as a CD-R, DVD-R, flash drive, a platter of a hard disk drive, etc., on which is encoded computer-readable data 906. This computer-readable data 906, such as binary data including a plurality of zero's and one's as shown in 906, in turn includes a set of computer instructions 904 configured to operate according to one or more of the principles set forth herein. In one such embodiment 900, the processor-executable computer instructions 904 are configured to perform a method 902, such as the method 200 of FIG. 2 or the method 300 of FIG. 3. In another embodiment, the processor-executable instructions 904 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 10 and the following discussion provide a description of a suitable computing environment to implement embodiments of one or more of the provisions set forth herein. The operating environment of FIG. 10 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 10 illustrates a system 1000 including a computing device 1012 configured to implement one or more embodiments provided herein. In one configuration, computing device 1012 includes at least one processing unit 1016 and memory 1018. Depending on the exact configuration and type of computing device, memory 1018 may be volatile, such as RAM, non-volatile, such as ROM, flash memory, etc., or a combination of the two. This configuration is illustrated in FIG. 10 by dashed line 1014.

In other embodiments, device 1012 includes additional features or functionality. For example, device 1012 may include additional storage such as removable storage or non-removable storage, including, but not limited to, magnetic storage, optical storage, etc. Such additional storage is illustrated in FIG. 10 by storage 1020. In one or more embodiments, computer readable instructions to implement one or more embodiments provided herein are in storage 1020. Storage 1020 may store other computer readable instructions to implement an operating system, an application program, etc. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 1012. Any such computer storage media is part of device 1012.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1012 includes input device(s) 1024 such as keyboard, mouse, pen, voice input device, touch input device, infrared cameras, video input devices, or any other input device. Output device(s) 1022 such as one or more displays, speakers, printers, or any other output device may be included with device 1012. Input device(s) 1024 and output device(s) 1022 may be connected to device 1012 via a wired connection, wireless connection, or any combination thereof. In one or more embodiments, an input device or an output device from another computing device may be used as input device(s) 1024 or output device(s) 1022 for computing device 1012. Device 1012 may include communication connection(s) 1026 to facilitate communications with one or more other devices.

According to one or more aspects, system for managing vehicle velocity is provided, including a slope component receiving slope information associated with a driving environment of a vehicle. The system may include a controller area network (CAN) receiving a current velocity associated with the vehicle. The system may include a determination component calculating an estimated velocity for the vehicle based on the current velocity of the vehicle and the slope information associated with the driving environment of the vehicle. The system may include a control component adjusting a velocity of the vehicle based on the estimated velocity and the slope information.

In one or more embodiments, the slope information may include topological data associated with the driving environment of the vehicle. The driving environment may include one or more portions of a route and one or more portions of the route are associated with corresponding slope information. The system may include a location component receiving a current location associated with the vehicle. The slope information may be associated with current location of the vehicle. The location component may be a global positioning system (GPS) receiver. The slope component may receive the slope information based on a global positioning system (GPS) location of the vehicle. The controller area network (CAN) may receive acceleration information or a steering angle associated with the vehicle.

The system may include a display component for displaying slope information, a slope angle, or driving environment information to an occupant of the vehicle. The system may include an audio component for rendering a notification associated with adjusting the velocity of the vehicle. The control component may adjust the velocity of the vehicle by accelerating or decelerating the vehicle.

According to one or more aspects, a method for managing vehicle velocity is provided, including referencing slope information associated with a driving environment of a vehicle, receiving a current velocity associated with the vehicle, determining whether to accelerate, decelerate, or coast based on the current velocity of the vehicle and the slope information associated with driving environment of the vehicle, and controlling a velocity of the vehicle based on the determination.

In one or more embodiments, the driving environment may include one or more portions of a route, wherein one or more portion of the route may include one or more road segments, and wherein one or more road segments are associated with corresponding slope information. Referencing the slope information may be based on a global positioning system (GPS) location associated with the vehicle. The slope information may include topological data or a slope angle associated with one or more road segments of the driving environment of the vehicle. The method may include calculating an estimated velocity for the vehicle based on the current velocity of the vehicle and the slope information associated with the driving environment of the vehicle or controlling the velocity of the vehicle via a cruise control component.

According to one or more aspects, a computer-readable storage medium including computer-executable instructions, which when executed via a processing unit on a computer performs acts, including receiving slope information associated with a driving environment of a vehicle, receiving a current velocity associated with the vehicle, calculating an estimated velocity for the vehicle based on the current velocity of the vehicle and the slope information associated with the driving environment of the vehicle, and adjusting a velocity of the vehicle based on the estimated velocity and the slope information. In one or more embodiments, the computer may perform an act of receiving a current location associated with the vehicle, wherein the slope information is associated with current location of the vehicle. In one or more embodiments, the slope information may include topological data associated with the driving environment of the vehicle. The driving environment may include one or more portions of a route and one or more portions of the route may be associated with corresponding slope information.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or “including, but not limited to”.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for managing vehicle velocity, comprising:
a slope component receiving slope information associated with a driving environment of a vehicle;
a controller area network (CAN) receiving a current velocity associated with the vehicle;
a determination component calculating an estimated velocity for the vehicle based on the current velocity of the vehicle and the slope information associated with the driving environment of the vehicle; and
a control component adjusting a velocity of the vehicle based on the estimated velocity and the slope information.

2. The system of claim 1, wherein the slope information comprises topological data associated with the driving environment of the vehicle.

3. The system of claim 1, wherein the driving environment comprises one or more portions of a route and one or more portions of the route are associated with corresponding slope information.

4. The system of claim 1, comprising a location component receiving a current location associated with the vehicle, wherein the slope information is associated with current location of the vehicle.

5. The system of claim 4, wherein the location component is a global positioning system (GPS) receiver.

6. The system of claim 1, wherein the slope component receives the slope information based on a global positioning system (GPS) location of the vehicle.

7. The system of claim 1, wherein the CAN receives acceleration information or a steering angle associated with the vehicle.

8. The system of claim 1, comprising a display component displaying slope information, a slope angle, or driving environment information to an occupant of the vehicle.

9. The system of claim 1, comprising an audio component rendering a notification associated with adjusting the velocity of the vehicle.

10. The system of claim 1, wherein the control component adjusts the velocity of the vehicle by accelerating or decelerating the vehicle.

11. A method for managing vehicle velocity, comprising:
referencing slope information associated with a driving environment of a vehicle;
receiving a current velocity associated with the vehicle;
determining whether to accelerate, decelerate, or coast based on the current velocity of the vehicle and the slope information associated with driving environment of the vehicle; and
controlling a velocity of the vehicle based on the determination, wherein the referencing, the receiving, the determining, or the controlling is implemented via a processing unit.

12. The method of claim 11, wherein the driving environment comprises one or more portions of a route, wherein one or more portion of the route comprise one or more road segments, and wherein one or more of the road segments are associated with corresponding slope information.

13. The method of claim 11, wherein referencing the slope information is based on a global positioning system (GPS) location associated with the vehicle.

14. The method of claim 11, wherein the slope information comprises topological data or a slope angle associated with one or more road segments of the driving environment of the vehicle.

15. The method of claim 11, comprising calculating an estimated velocity for the vehicle based on the current velocity of the vehicle and the slope information associated with the driving environment of the vehicle.

16. The method of claim 11, comprising controlling the velocity of the vehicle via a cruise control component.

17. A computer-readable storage medium comprising computer-executable instructions, which when executed via a processing unit on a computer performs acts, comprising:
receiving slope information associated with a driving environment of a vehicle;
receiving a current velocity associated with the vehicle;
calculating an estimated velocity for the vehicle based on the current velocity of the vehicle and the slope information associated with the driving environment of the vehicle; and
adjusting a velocity of the vehicle based on the estimated velocity and the slope information.

18. The computer-readable storage medium of claim 17, wherein the slope information comprises topological data associated with the driving environment of the vehicle.

19. The computer-readable storage medium of claim 17, wherein the driving environment comprises one or more portions of a route and one or more portions of the route are associated with corresponding slope information.

20. The computer-readable storage medium of claim 17, comprising receiving a current location associated with the vehicle, wherein the slope information is associated with current location of the vehicle.
